(19) United States
(12) Patent Application Publication
(10) Pub. No.: US 2026/0071683 A1
(43) Pub. Date: Mar. 12, 2026

(54) ROTARY VALVE

(71) Applicant: KITZ CORPORATION, Tokyo (JP)

(72) Inventor: Yukihiro MIYASHITA, Nagano (JP)

(21) Appl. No.: 19/107,323

(22) PCT Filed: Aug. 30, 2023
(86) PCT No.: PCT/JP2023/031383

§ 371 Date: Feb. 27, 2025

(30) Foreign Application Priority Data
Sep. 1, 2022 (JP) 2022-139364

(51) Int. Cl. F16K 1/226

(52) U.S. Cl. CPC F16K 1/2268

(57) ABSTRACT

A packing accommodation chamber is provided inside a stem shaft insertion portion on an operating portion side, a diameter-reduced portion is provided on the operating portion side, a diameter-enlarged portion is provided on a valve disk side of the stem, a diameter-reduced step surface is formed at a boundary portion therebetween, a gland having a packing pressing portion is provided on the operating portion side, a packing retaining member is interposed between a lower end face of the packing pressing portion and a packing. The diameter-reduced step surface is arranged at least lower than the packing retaining member, the diameter-enlarged portion has an outer diameter S2 larger than an inner diameter S7 of the packing retaining member and, when the stem rises to the operating portion side, the diameter-reduced step surface is locked to the packing retaining member to prevent pullout of the stem to the operating portion side.

### TECHNICAL FIELD

The present invention relates to a rotary valve such as a butterfly valve and, in particular, to a rotary valve that is suitable when a packing for stem sealing is pressed to a shaft insertion portion of a stem.

### BACKGROUND ART

Conventionally, as a rotary valve of this type, for example, an eccentric butterfly valve for letting a fluid at high temperature or with high pressure has been known. In the eccentric butterfly valve, normally, a packing for stem sealing is attached to a stem outer circumferential side to prevent leakage of high-pressure, high-temperature fluid from a shaft insertion portion, and this packing is pressed by a gland provided on an upper side of the packing to enhance shaft sealability of the stem.

In this case, in the eccentric butterfly valve, the structure is often such that the stem and the valve disk are fixed with pins or the like. When damage, rupture, or the like occur at any of these fixing locations due to some cause, there is a possibility that the stem is removed from the valve disk to be pulled out to the outside of the body. To address this, a rotary valve that prevents pullout of the stem by using the above-described gland has been generally known. In recent years, standards and regulations regarding stem pullout prevention may be defined. The stem pullout prevention structure as described above is provided normally to a location where no fluid makes contact, that is, on an operating portion side of the stem on an upper side of the packing.

As a rotary valve having the stem pullout prevention function of this type, for example, one trying to inhibit pullout of the stem by using a retaining ring has been known. For example, in the butterfly valve disclosed in Patent Literature 1, annular groove is formed at a predetermined position of the stem for attachment of a C-type retaining ring, and the C-type retaining ring fits in this annular groove to provide a locking portion in a diameter-enlarged shape. On the other hand, in a gland for pressing a packing, a stem hole with an inner diameter that allows the stem with the C-type retaining ring attached thereto to rise is formed. Furthermore, on an upper portion of the gland, an annular locking surface in a diameter-reduced shape is integrally formed to lock the C-type retaining ring (FIG. 2A, FIG. 2B, FIG. 5A, and FIG. 5B of Literature 1).

At the time of rising of the stem, the C-type retaining ring moves from a portion near a lower portion to an upper portion side of the gland through the stem hole and, with this C-type retaining ring locked to an annular locking surface, stem pullout is tried to be prevented.

In Patent Literature 1, a butterfly valve is also disclosed in which a first portion (diameter-enlarged portion) having a first diameter and a second portion (diameter-reduced portion) having a second diameter are formed on a stem and a step for prevention of pullout is formed between these first portion and second portion as a locking portion (FIG. 1A and FIG. 1B of Literature 1). In this structure, the step (locking portion) moves by rising of the stem from a portion near a lower portion to an upper portion side of the gland through the stem hole, and is locked to an annular locking surface in a diameter-reduced shape integrally formed on the upper portion side of the gland, thereby trying to prevent pullout of the stem.

When the stem hole is formed in the gland of each of these butterfly valves, to suppress an occurrence of, for example, galling due to a contact of the locking portion (C-type retaining ring or step) because of the tilt of the stem, and to allow formation with a size usable directly in a casted state without processing, a portion for accommodating the locking portion is required to be provided so as to have an inner diameter on the order of being being equal to or larger than the outer diameter of this locking portion. From this, a large space is provided between the inner circumference of the stem hole of the gland and the outer circumference side of the stem. The locking portion (C-type retaining ring or step) moves through this space, while the stem rises.

### CITATION LIST

### Patent Literature

PTL 1: Japanese Patent No. 5580321

### SUMMARY OF INVENTION

### Technical Problem

In the case of the rotary valve of Patent Literature 1, the stem hole of the gland is required to be formed so as to have a hole diameter that allows the locking portion (C-type retaining ring or step) of the stem to rise, the annular locking surface on the upper portion of the gland is required to be formed with a size that allows the locking portion to be locked to prevent pullout of the stem, and special processing for providing these is required to be performed on the stem and the gland. In this case, the stem hole requires a predetermined length for the locking portion to move and, furthermore, this length is long because the locking portion moves from a portion near the lower portion to the annular locking surface on the upper side of the gland. This poses also a problem in which the entire gland becomes long and the size of the entire valve is increased to a stem axial direction.

Moreover, when a space is provided between the inner circumference of the stem hole of the gland and the outer circumferential side of the stem, to ensure strength of the gland while ensuring the size of this space in a radial direction, it is required to enlarge the diameter of the gland to ensure its thickness. When the diameter of the gland is enlarged in this manner, the diameter of a shaft insertion portion of the body into which this gland is to be inserted is also thick, leading to an increase in size of the entire valve around the rotation axis.

At the time of assembling, when the gland is mounted on the body, the gland tends to be titled against the body and the stem due to the above-described space. Since the annular locking surface of the gland has a (diameter-reduced) shape protruding toward an inner diameter side in a flange shape, if the gland is tilted after assembling, the rising stem tends to interfere with the annular locking surface, and there is a possibility of damage such as galling mainly nearby this portion.

In addition, after assembling, the inner diameter side of the bottom surface of the gland does not contact with the upper surface of the packing due to the above-described space, and the state is such that only the outer circumferential side of the bottom surface of the gland abuts on the upper surface of the packing. Thus, a portion near the inner circumferential side of the packing cannot be pressed by the gland, and there is a possibility that seal surface pressure with the outer circumferential side of the stem on which this packing abuts is insufficient.

Furthermore, in the structure in which the stem is prevented from being pulled out by using the C-type retaining ring of Patent Literature 1 (FIG. 2A, FIG. 2B, FIG. 5A, and FIG. 5B of Literature 1), in addition to the above-described common problems, the C-type retaining ring is separately required as a component for locking the stem to prevent pullout, and an annular groove for attachment of this C-type retaining ring is required to be processed at a predetermined position of the stem.

At the time of assembling, an effort of attaching the C-type retaining ring to the annular grove also occurs. In this case, since the C-type retaining ring is attached at a position upper than the packing, depending on the structure of a bearing to be attached to the stem or the like and so forth, the packing is attached prior to the C-type retaining ring. In addition to this, the mount position of the C-type retaining ring is often inside the shaft insertion portion of the body or at a position slightly upper than that. Thus, the shaft insertion portion tends to be an obstacle at the time of mounting the C-type retaining ring.

For example, when the rotary valve is a butterfly valve, it is also required to support a lower portion side of the stem. Thus, for example, when an integral-type stem protruding upward and downward from the valve disk is used, a split ring may be used for fixing the position of a lower portion of the stem. In this case, if a C-type retaining ring for position restriction is attached to an upper portion of the stem as in Patent Literature 1 described above, after the split ring is attached to the lower portion side of the stem, this split ring is caught on a lower end edge side of the stem insertion hole, and the stem cannot be moved further upward against the body. On the other hand, after the C-type retaining ring is attached to the upper portion side of the stem, the C-type retaining ring is caught on an upper end edge side of the stem insertion hole, and the stem cannot be moved further downward against the body. From these there is a problem in which assembling is cumbersome.

When the gland is attached to the body, a tip side of the gland may make contact with and be caught on the C-type retaining ring. This causes an inconvenience such as deformation or falloff of the C-type retaining ring, leading to inability of prevention of pullout of the stem. Also, with the gland interfering with the C-type retaining ring, additional fastening of the packing cannot be made.

As these described above, in the rotary valve in the structure in which the C-type retaining ring is locked to the gland to prevent stem pullout, assembling process is complex, and the stem pullout prevention function may be damaged after assembling. Furthermore, there is also a possibility that the C-type retaining ring is removed by a popup impact from the groove of the stem and the stem pullout prevention function is lost.

Also, at the time of additional fastening by the gland in response to crush, etc. of the packing, if a margin of space between the annular locking surface and the C-type retaining ring in an up-down direction is small, there is also a problem in which the C-type retaining ring makes contact with the annular locking surface early, making it difficult to further additionally fastening the gland to cause shaft sealing performance to become insufficient.

On the other hand, in the structure in which the locking portion by the step is provided between the first portion (diameter-enlarged portion) and the second portion (diameter-reduced portion) of Patent Literature 1 and this step is locked to the annular locking surface on the upper portion side of the gland (FIG. 1A and FIG. 1B of Literature 1) to prevent the stem from being pulled out, in addition to the above-described common problems, if the size of the step (locking portion) in a radial direction is small, there is a problem in which locking of the step to the annular locking surface is insufficient due to tilt of the gland because of the space described above, making pullout prevention impossible. To reliably prevent pullout of the stem by the step, it is required to widen the dimension of the step in the radial direction to increase the locking area (abutting area) with the annular locking surface. To do this, processing is required to reduce the diameter of the stem to widen the step. In this case, at the time of assembling, the space between the outer circumference of the stem and the inner circumference of the gland is widened, and a possibility occurs in which the gland is attached in a state of being greatly tilted against the body and the stem.

In addition to this, when a dihedral portion and a corner portion for mounting a handle or an actuator and provided at an end portion on an operation side of the diameter-reduced portion, it is required to ensure the thickness of these portions to some extent to obtain sufficient strength. Thus, high processing accuracy may be demanded.

The present invention was developed to solve the conventional problems, and has an object of providing a compact rotary valve in which a stem pullout prevention function can be provided without requiring special processing or an additional component and, in a state in which excellent sealability by a packing is ensured, a shaft insertion portion of a stem is accurately and easily assembled to allow reliable prevention of pullout of the stem.

### Solution to Problem

To achieve the above-described object, the invention according to claim 1 is directed to a rotary valve in which a valve disk is provided inside a body having a stem shaft insertion portion, one end of a stem shaft-inserted into the stem shaft insertion portion is connected to the valve disk and another end thereof is connected to an operating portion, and the valve disk is rotatably provided via the stem by operation of the operating portion, wherein a packing accommodation chamber for packing accommodation is provided inside the stem shaft insertion portion on the operating portion side, a diameter-reduced portion is provided on the operating portion side of the stem, a diameter-enlarged portion with a diameter enlarged more than the diameter-reduced portion is provided on the valve disk side of the stem, a diameter-reduced step surface is formed at a boundary portion between these diameter-reduced portion and diameter-enlarged portion, a gland having a packing pressing portion is provided on the operating portion side of the stem, an annular packing retaining member is interposed between a lower end face of the packing pressing portion and the packing, the diameter-reduced step surface is arranged at least lower than the packing retaining member, the diameter-enlarged portion has an outer diameter larger than an inner diameter of the packing retaining member and, when the stem rises to the operating portion side, the diameter-reduced step surface is locked to the packing retaining member to prevent pullout of the stem to the operating portion side.

The invention according to claim 2 is directed to the rotary valve in which the diameter-reduced step surface is formed as a flat surface, a tapered surface, or a rounded surface.

The invention according to claim 3 is directed to the rotary valve, in which the diameter-reduced step surface is positioned lower than the packing accommodation chamber.

The invention according to claim 4 is directed to the rotary valve, in which a diameter-reduced-shape portion is formed on a circumferential surface of the stem on a valve disk side of the diameter-reduced step surface, and a bearing is attached to this diameter-reduced-shape portion.

### Advantageous Effects of Invention

From the invention according to claim 1, it is possible to provide a pullout prevention function to the stem without applying special process or additionally requiring a new component to the stem and the gland. When the stem rises to the operating portion side, the diameter-reduced step surface in which its outer diameter is defined by the diameter-enlarged portion with an outer diameter larger than the inner diameter of the packing retaining member is locked to the packing retaining member, and further movement of this packing retaining member to the operating portion side is restricted by the lower end face of the packing pressing portion of the gland, thereby restricting further rising of the stem and allowing the stem from being reliably prevented from being pulled out to the operating portion side. At the time of assembling, in a state in which the packing retaining member is interposed between the gland on the operating portion side and the general-purpose packing, only by assembling these together with the stem to the body, it is possible to accurately and easily assemble the stem shaft insertion portion in a state in which excellent sealability by the packing is ensured, and it is possible to easily configure a stem pullout prevention structure. The packing retaining member can have its outer diameter equal to the inner diameter of the packing accommodation chamber, and can also have its inner diameter minimum so as not to cause galling with the stem, by way of example. Thus, compared with the case in which the stem hole is provided on the inner circumference of the gland, the inner and outer diameters can be easily set minimum, and it is not required to ensure an excessive space for installation. Thus, it is possible to prevent an increase in size of the gland and the body, and make the entirety compact, in a state in which strengths of these gland and stem are ensured. Also, since the lower end face of the packing pressing portion of the gland can press most of the surface on an abutting side of the packing retaining member, it is possible to enhance the entire seal surface pressure from the inner circumferential side to the outer circumferential side of the packing. In addition, the packing retaining member can press from the outer circumferential side to a position extremely near the inner circumference of the packing. Thus, it is possible to uniformly press the entire packing to significantly improve shaft sealability, and also recover shaft sealability by additional fastening of the gland.

Furthermore, by adjusting the pressing force to the packing from the gland, it is possible to enhance shaft sealability by the packing while improving torque capability at the time of rotating operation of the stem. In a state in which both of these torque capability and sealability are ensured, it is possible to provide a structure of exerting a pullout prevention function of the stem of the valve body from a small diameter to a large diameter. Since it is possible to mount the gland in a state in which the diameter-reduced portion fits in the inner circumferential surface of the gland, it is possible to suppress vibration of the stem and tilt of the gland against the body and perform accurate rotation control of the valve disk.

From the invention according to claim 2, the diameter-reduced step surface is formed as a flat surface, a tapered surface, or a rounded surface. With this, the diameter-reduced step surface is caused to annually abut on the packing retaining member in surface contact or linear contact to apply a force also to a radial direction, thereby allowing an improvement in performance of stem pullout prevention. Also when the diameter-reduced step surface is provided in any shape of a flat surface, a tapered surface, and a rounded shape, equivalent performance of stem pullout prevent is exerted. In particular, when a diameter-reduced step surface by a flat surface is provided between the diameter-enlarged portion and the diameter-reduced portion, this diameter-reduced step surface is in surface contact with a bottom surface side of the packing retaining member with a substantially uniform force, thereby preventing a force titled to a gland side from being applied from the stem and allowing the stem to be reliably prevented from being pulled out. When a diameter-reduced step surface by a tapered surface or a rounded surface is provided between the diameter-enlarged portion and the diameter-reduced portion, processing the stem is easy. When the stem pullout prevention function is exerted, the direction in which a force to be applied to the packing retaining member is distributed by the tapered surface or the rounded surface. Thus, at the time of stem pullout prevention, an impact can be made small, and also damage and so forth of the stem and the packing pressing member can also be prevented.

While a dimensional error is absorbed through the tapered surface or the rounded surface, an extremely narrow diameter-reduced portion can also be provided with respect to the diameter-enlarged portion. By changing the diameter of the diameter-reduced portion, it is possible to use a common stem for a valve body with a different diameter.

From the invention according to claim 3, the diameter-reduced step surface is positioned lower than the packing accommodation chamber. With this, while the surface of the diameter-enlarged portion of the stem is kept being a relatively rough surface in a casting surface state, and can be made as a smooth surface simultaneously with diameter-reducing processing for the diameter-reduced portion in contact with the packing. With this, the packing can be adhered to the surface of the diameter-reduced portion, which is a contact surface in the stem with the packing, to improve sealability around the stem. While sealability at the packing attachment portion is sufficiently ensured, processing of the stem at the diameter-enlarged portion can be made almost unnecessary. Thus, processing becomes easy, and a reduction in cost can be made.

From the invention according to claim 4, a diameter-reduced-shape portion is formed on a circumferential surface of the stem on a valve disk side of the diameter-reduced step surface, and a bearing is attached to this diameter-reduced-shape portion. With this, vibration on the upper portion side of the stem is suppressed to prevent tilt of the stem on a packing attachment side and thereabove, and it is possible to smoothly rotate the stem while improving sealability by the packing. Also, by preventing tilt of the stem, stem pullout prevention performance is also improved.

In this case, by providing the diameter-reduced-shape portion having an outer diameter substantially equal to that of the diameter-reduced portion, it is possible to form only a portion near the diameter-reduced step surface in a state of an annular flange portion extruding to the outer circumference. Since it is not required to change the degree of processing on an up-down side across this portion near the diameter-reduced step surface, processing of the stem is easy. Since the diameter-reduced portion can be formed so as to match the diameter of the diameter-reduced-shape portion so that the diameter is only slightly reduced to an extent of the thickness of the bearing, it is possible to suppress an excessive reduction of the diameter of the diameter-reduced portion and ensure strength. Thus, in particular, this is suitable when the stem is relatively narrow as a valve having a smaller diameter, and it is possible to form a diameter-reduced step surface reliably exerting a pullout prevention function also to this stem having a small diameter.

On the other hand, when the diameter-reduced-shape portion is provided so as to have a diameter larger than the outer diameter of the diameter-reduced portion, the outer diameter on a diameter-reduced portion side can be set any. In this manner, a diameter-reduced portion having a different outer diameter can be formed to the stem of the diameter-enlarged portion having a predetermined outer diameter. Thus, the stem can also be used for a valve body with a size smaller than a valve body as a target. Thus, this is suitable, in particular, when the stem is relatively thick as a valve having a large diameter.

### BRIEF DESCRIPTION OF DRAWINGS

FIG. 1 is a longitudinal sectional view depicting a first embodiment of a rotary valve of the present invention.

FIG. 2 is an enlarged sectional view of main portions of FIG. 1.

FIG. 3 is a perspective view depicting disassembled main portions in FIG. 1.

FIG. 4 is an enlarged sectional view of main portions depicting a state in which a stem of FIG. 2 rises.

FIG. 5 is a longitudinal sectional view depicting a second embodiment of the rotary valve of the present invention.

FIG. 6 is an enlarged sectional view of main portions of FIG. 5.

### DESCRIPTION OF EMBODIMENTS

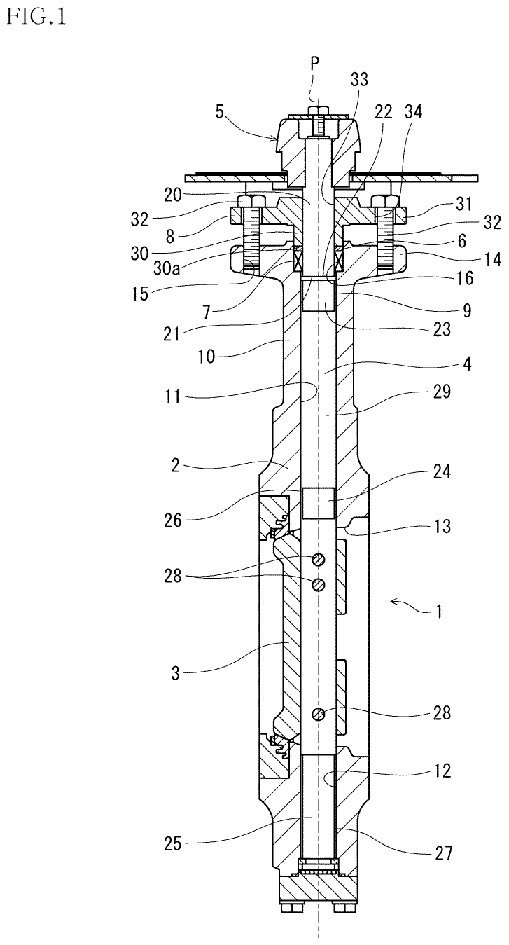

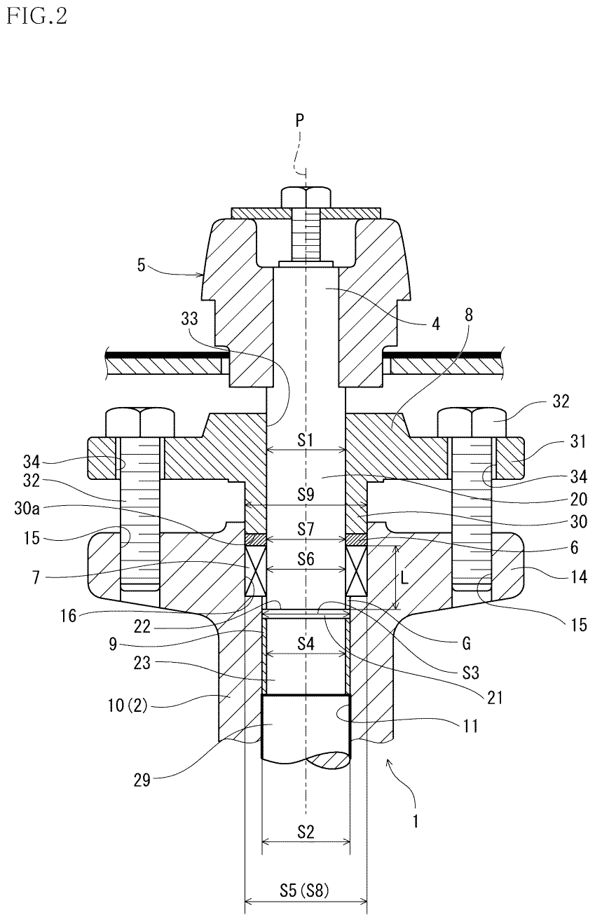

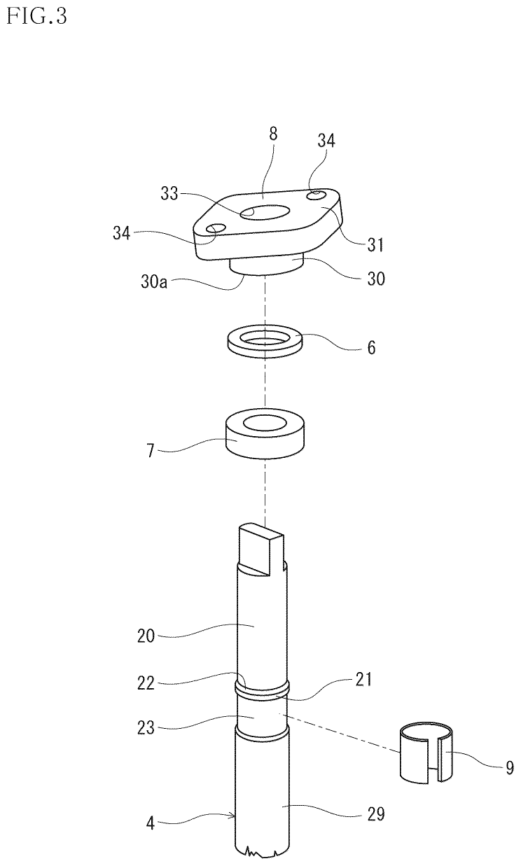

In the following, embodiments of the rotary valve in the present invention are described in detail based on the drawings. In FIG. 1, a longitudinal sectional view of a first embodiment of the rotary valve is depicted, FIG. 2 is an enlarged sectional view of main portions of FIG. 1, and FIG. 3 is a perspective view depicting disassembled main portions in FIG. 1.

In FIG. 1 to FIG. 3, the rotary valve (hereinafter referred to as a valve body 1) in the present embodiment is formed of an eccentric butterfly valve. The valve body 1 includes a body 2, a valve disk 3, a stem 4, an operating portion 5, a packing retaining member 6, a packing 7, a gland 8, and a bearing 9.

An upper portion of the body 2 of the valve body 1 is provided with a stem shaft insertion portion 10, and this stem shaft insertion portion 10 has an upper through hole 11 formed inside. On a lower side of the body 2, a lower through hole 12 is formed, and a fluid flow path 13 is provided between the upper through hole 11 and the lower through hole 12. The valve disk 3 is provided to a fluid flow path 13 side inside the body 2, and one end of the stem 4 shaft-inserted to the stem shaft insertion portion 10 is connected to this valve disk 3. The stem 4 is inserted into the inside of the body 2 through the upper through hole 11 and the lower through hole 12.

The other end of the stem 4 is connected to the operating portion 5 formed of a manual handle, and the valve body 1 has the valve disk 3 rotatably provided via the stem 4 with operation of the operating portion 5.

A flange-shaped mount portion 14 is formed on an upper portion of the stem shaft insertion portion 10, and a plurality of bolt holes 15 are provided at predetermined positions of this mount portion 14. Through these bolt holes 15, as will be described further below, the gland 8 is provided so as to be mountable to the mount portion 14.

Inside the stem shaft insertion portion 10 on operation side, a packing accommodation chamber 16 having a diameter enlarged more than the upper through hole 11 for accommodation of a packing is provided so as to have a predetermined depth, and the packing 7 and the packing retaining member 6 are inserted from above in this sequence into this packing accommodation chamber 16.

The stem 4 is formed in an elongated integrated shape, is provided with a diameter-reduced portion 20 in a reduced diameter shape on an operating portion 5 side of this stem 4 and, on a valve disk 3 side of the stem 4, has a diameter-enlarged portion 21 with its diameter enlarged more than the diameter-reduced portion 20, a diameter-reduced-shape portion 23 therebelow, and a stem portion 29 further therebelow.

The diameter-reduced portion 20 is formed on an upper side of the stem 4, and is provided so that, as for the length of this diameter-reduced portion 20, the diameter is reduced to a portion where the stem 4 is arranged in the packing accommodation chamber 16, desirably to a position lower than the packing accommodation chamber 16, when the stem 4 is shaft-inserted to a predetermined position of the stem shaft insertion portion 10 (upper through hole 11, lower through hole 12).

The diameter-enlarged portion 21 is formed below the diameter-reduced portion 20 of the stem 4, and a diameter-reduced step surface 22 is formed at an upper end position of this diameter-enlarged portion 21, that is, a boundary portion between the diameter-reduced portion 20 and the diameter-enlarged portion 21. While this diameter-enlarged portion 21 and the stem portion 29 of the stem 4 have the same diameter in the present example, these portions may have different diameters as required.

The above-described diameter-reduced portion 20 is provided so as to have a size with its diameter slightly reduced with respect to the diameter-enlarged portion 21 and is formed so that, by way of example, when the valve is a butterfly valve having its diameter on the order of 4 inches, an outer diameter S1 of the diameter-reduced portion 20 is on the order of φ16 mm and an outer diameter S2 of the diameter-enlarged portion 21 and the stem portion 29 is on the order of φ17 mm.

The diameter-reduced step surface 22 is formed between the diameter-reduced portion 20 and the diameter-enlarged portion 21 by, for example, processing means such as one for machining. This diameter-reduced step surface 22 is arranged at least lower than the packing retaining member 6 and, when the stem 4 rises to the operating portion 5 side, the diameter-reduced step surface 22 is locked to the packing retaining member to prevent the stem 4 from being pulled out to the operating portion 5 side.

In the present embodiment, the diameter-reduced step surface 22 is provided at a position lower than the packing accommodation chamber 16 with respect to the body 2, and an annular gap portion G is provided between these diameter-reduced step surface 22 and packing accommodation chamber 16.

The diameter-reduced step surface 22 is provided by an annular flat surface, tapered surface, or rounded surface and, in the present example, is formed of an annular flat surface in a direction perpendicular to a rotation axis P of the stem 4.

On the circumferential surface of the stem 4 on a valve disk 3 side of the diameter-reduced step surface 22, a diameter-reduced-shape portion 23 having an outer diameter S4 more diameter-reduced than an outer diameter S3 of the diameter-reduced step surface 22 is formed as having a predetermined width (height). To this diameter-reduced-shape portion 23, the bearing 9 is attached and, by this bearing 9, vibration of the stem 4 near an attachment side to the packing 7 is suppressed. The bearing 9 (diameter-reduced-shape portion 23) is more preferably provided at a position near the packing 7, that is, near the diameter-reduced step surface 22 and, in this case, vibration of a portion of the stem 4 on a side upper than the packing 7 attachment side can be further suppressed. In the present example, the outer diameter S4 of the diameter-reduced-shape portion is provided so as to be substantially equal to the outer diameter S1 of the diameter-reduced portion.

Also, on the circumferential surface of the stem 4 near a center portion and a lower end portion in a length direction, diameter-reduced annular portions 24 and 25 are formed each having an outer diameter more diameter-reduced than the outer diameter S2 of the diameter-enlarged portion 21. To these diameter-reduced annular portions 24 and 25, bearing members 26 and 27 are attached, respectively. By each of these bearing members 26 and 27, vibration of the stem 4 near an attachment side to the valve disk 3 is suppressed.

The bearing 9 and the bearing members 26 and 27 are each formed in a belt shape and of a material with flexibility suitable for bearing of the stem 4. The bearing 9 and the bearing members 26 and 27 are provided so as to have a width substantially equal to the width of the diameter-reduced-shape portion 23, a width substantially equal to the width of the diameter-reduced annular portion 24, and a width substantially equal to the width of the diameter-reduced annular portion 25, respectively; are provided so as to have a length substantially equal to the outer circumference of the diameter-reduced-shape portion 23, a length substantially equal to the outer circumference of the diameter-reduced annular portion 24, and a length substantially equal to the outer circumference of the diameter-reduced annular portion 25, respectively; and are provided so as to have a substantially thickness equal to the depth of the diameter-reduced-shape portion 23, a depth substantially equal to the depth of the diameter-reduced annular portion 24, and a depth substantially equal to the depth of the diameter-reduced annular portion 25, respectively. With these, the bearing 9 and the bearing members 26 and 27 are attached so as to be wound around once to the respective attachment locations. After attachment, they each become in a state with one surface side abutting on the stem outer circumferential surface, and the other surface side abutting on the inner circumferential surface of the body 2 (inner circumference of the upper through hole 11, inner circumference of the lower through hole 12), and this ensures slidability of the step at the time of operation of the stem 4.

The stem 4 is, with the above-described bearing 9 and bearing members 26 and 27 attached thereto, attached from the upper through hole 11 to the lower through hole 12 from above the body 2 to be shaft-inserted into the stem shaft insertion portion 10. In this state, the valve disk 3 is fixedly attached to a predetermined position of the stem 4 with a plurality of pins 28, and this valve disk 3 is arranged at a position that is eccentric against the rotation axis P in the fluid flow path 13. With this, the valve disk 3 rotates in an eccentric state with rotation of the stem 4 and, at the time of valve closing, high sealability is exerted from its eccentric structure to prevent fluid leakage.

To the packing accommodation chamber 16 on the outer circumference of the diameter-reduced portion 20 of the stem 4, the packing 7 is attached. This packing 7 is annularly formed of an elastic material such as a resin material (for example, PTFE). The packing is provided to have an outer diameter S5 substantially equal to the inner circumferential surface of the packing accommodation chamber 16, the packing 7 has an inner diameter S6 substantially equal to the outer diameter S1 of the diameter-reduced portion 20 and smaller than an inner diameter S7 of the packing retaining member 6.

With this, the outer circumferential surface of the diameter-reduced portion 20 of the stem 4 adheres to and seals the inner circumferential surface of the packing 7, the outer circumferential surface of the packing 7 adheres to and seals the inner circumferential surface of the packing accommodation chamber 16 and, with this packing 7, the stem 4 is attached to the stem shaft insertion portion 10 in a state in which the stem 4 is shaft-sealed. To an upper portion of the packing 7, the packing retaining member 6 is attached. To an upper portion of this packing retaining member 6, the gland 8 is attached.

The packing retaining member 6 is formed of a packing washer, and this packing washer 6 is annularly formed and is provided to have an area that can pressure a substantially entire surface on an upper surface side of the packing 7. The packing washer 6 is provided to have the inner diameter S7 that is smaller than the outer diameter S3 of the diameter-reduced step surface and allows the diameter-reduced portion 20 to be inserted thereto. On the other hand, the packing washer 6 is provided to have an outer diameter S8 that is substantially equal to the outer diameter S5 of the packing 7 and allows a contact with the inner circumferential surface of the packing accommodation chamber 16. The packing washer 6 can be formed to have any thickness and, in particular, it is desirable to provide a thickness to the packing washer 6 to some extent and cause its outer circumferential surface side to abut on the inner circumferential surface of the packing accommodation chamber 16 to suppress tilt of the packing washer 6 against the packing accommodation chamber 16.

The gland 8 includes a packing pressing portion 30 and a flange-shaped protruding portion 31 projecting to an outer diameter side of this packing pressing portion 30, and is provided on the operating portion 5 side of the stem 4. The packing pressuring portion 30 is provided to have a cylindrical shape, and the protruding portion 31 is formed in a shape that can be fastened with fastening bolts 32 so as to correspond to the mount portion 14. At the center of the gland 8, an insertion hole 33 for insertion of the stem 4 is formed so as to penetrate therethrough. The packing pressing portion 30 is provided to have an outer diameter S9 that allows to be inserted into the packing accommodation chamber 16, and is provided so as to be able to press the packing washer 6 and the packing 7 on a lower end face 30a side of this packing pressing portion 30. In the protruding portion 31, through holes 34 are formed at positions corresponding to the above-described bolt holes 15.

In a state in which the stem 4 is inserted into the upper through hole 11 and the lower through hole 12 and the packing 7 and the packing washer 6 are accommodated in the packing accommodation chamber 16 on the outer circumferential side of the diameter-reduced portion 20 of this stem 4, the gland 8 is attached to the stem shaft insertion portion 10 from those described above. Here, the gland 8 is inserted into the packing accommodation chamber 16 until the lower end surface 30a of the packing pressing portion 30 abuts on the packing washer 6.

In this state, with the through holes 34 aligned with the positions of the bolt holes 15 and the fastening bolts 32 screwed from the through holes 34 into the bolt holes 15 with the fastening bolts 32, the packing 7 is pressed by the packing pressing portion 30 of the gland 8 via the packing washer 6, allowing a shaft sealing state to be achieved, thereby preventing fluid leakage from the stem shaft insertion portion 10. In this state, by adjusting the fastening amounts of the fastening bolts 32, it is possible to adjust the pressing force of the packing 7 and ensure slidability and shaft sealability at the time of operation of the stem 4. Furthermore, recovery of shaft sealability by additionally fastening the gland 8 is also possible.

With fastening of the fastening bolts 32, after the packing 7 and the packing washer 6 are fixed by the gland 8, the state becomes such that the packing washer 6 is interposed between the lower end face 30a of the packing pressing portion 30 and the packing 7. Here, with the outer diameter S2 of the diameter-enlarged portion set larger than the inner diameter S7 of the packing washer, as described above, when the stem 4 rises to the operating portion 5 side against the stem shaft insertion portion 10, the diameter-reduced step surface 22 is locked on an inner circumferential edge side of the packing washer 6 to prevent the stem 4 from being pulled out to the operating portion 5 side of the stem 4.

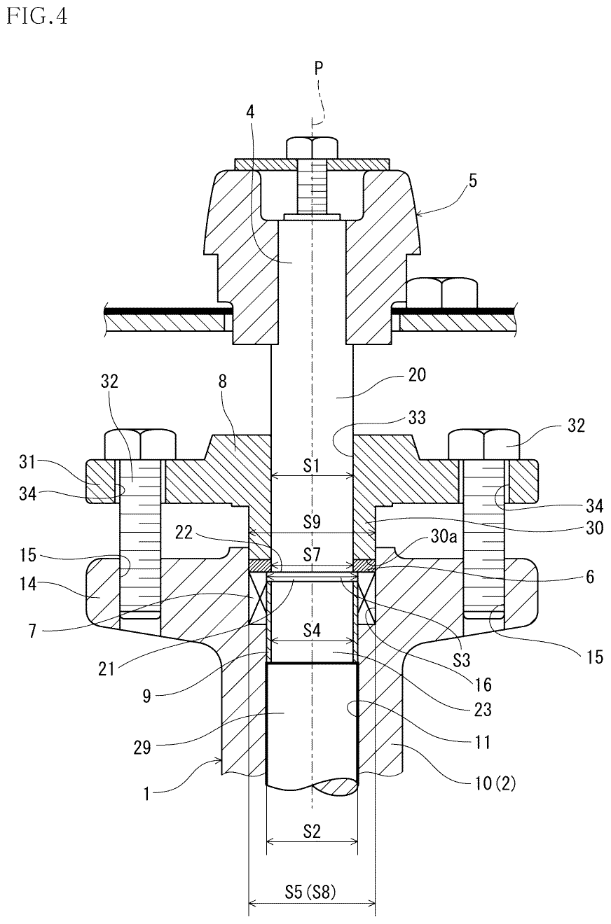

Here, in FIG. 2 and FIG. 4, a relation among the outer diameter S1 of the diameter-reduced portion, the outer diameter S2 of the diameter-enlarged portion, the outer diameter S3 of the diameter-reduced step surface, the outer diameter S4 of the diameter-reduced-shape portion, the outer diameter S5 of the packing, the inner diameter S6 of the packing, the inner diameter S7 of the packing washer, the outer diameter S8 of the packing washer, and the outer diameter S9 of the packing pressing portion is represented by the following equations (1) to (3), with those described above being also included.

$$T he inner diameter S 7 of the packing washer < the outer diameter S 2 of the diameter - enlarged portion = the outer diameter S 3 of the diameter - reduced step surface \qquad ( 1 )$$

$$The outer diameter S 1 of the diameter - reduced portion = the outer diameter S 4 of the diameter - reduced - shape portion = the inner diameter S 6 of the packing < the inner diameter S 7 of the packing washer < the outer diameter S 2 of the diameter - enlarged portion \qquad ( 2 )$$

$$The outer diameter S 1 of the diameter - reduced portion < the outer diameter S 8 of the packing washer = the outer diameter S 5 of the packing = the outer diameter S 9 of the packing pressing portion \qquad ( 3 )$$

In the present example, “=” in the above equations (1) to (3) includes the meaning of nearly equal, in addition to completely equal.

Note that the rotary valve of the present invention can be applied to a central butterfly valve other than an eccentric butterfly valve if the structure is such that the packing attached inside the stem shaft insertion portion is pressed by the gland via the packing retaining member to shaft sealing of the outer circumference of the stem. Furthermore, the present invention can be applied also to a ball valve or a rotary valve with another structure.

Also, if it is possible to prevent from pullout from the body 2 when the stem 4 rises to the operating portion 5 side, a component other than the packing washer 6 can also be used as a packing retaining member. That is, for example, in a state in which a packing retaining member separate from the packing washer is provided and the outer diameter of the diameter-enlarged portion of the stem is set larger than the inner diameter of this packing retaining member, it is only required that this packing retaining member is attached between the packing and the washer. In this case, the diameter-reduced step surface of the stem rising to the inner circumferential edge side of the packing retaining member can be locked, allowing prevention of pullout of the stem by pullout prevention capability equivalent to the one described above. Also, other than the case as in this example in which the packing washer and the packing retaining member are used both, for example, it can be configured that only the packing retaining member is used without the use of the packing washer.

The diameter-reduced step surface 22 may have a shape other than a flat surface, a tapered surface, or a rounded surface, and may be provided in a mode other than an annular shape. With this, for example, a diameter-reduced step surface may be formed between the diameter-reduced portion and the diameter-enlarged portion so as to partially protrude to a locking direction.

The diameter-reduced-shape portion 23 may be provided so as to have a diameter larger than the outer diameter S1 of the diameter-reduced portion on a packing 7 attachment side. In this case, as will be described further below, it is possible to provide a stem suitable for a large-diameter valve body. The diameter-reduced-shape portion 23 may be formed at a position away from the packing 7 (diameter-reduced step surface 22) to a lower direction if the stem 4 above the valve disk can be supported by the bearing 9 attached to this diameter-reduced-shape portion 23.

The stem may be provided as separate bodies formed of an upper stem and a lower stem and, in this case, pullout of the upper stem from a stem shaft insertion portion side can be prevented.

The bearing 9 is preferably provided near the packing 7 and the bearing member 26 is preferably provided at a position near the valve disk 3. These bearing 9 and bearing member 26 can be each omitted as required.

The operating portion 5 may be a manual operation mechanism other than a manual handle, and also may be provided as an automated operation mechanism such as an actuator not depicted.

Next, the action in the above-described embodiment of the rotary valve in the present invention is described.

As depicted in FIG. 1 to FIG. 4, in the valve body 1, the diameter-reduced step surface 22 is formed at a boundary portion between the diameter-reduced portion 20 and the diameter-enlarged portion 21 of the stem 4, and the gland 8 is provided on the operating portion 5 side of the stem 4. The packing washer 6 is interposed between the lower end surface 30a of that packing pressing portion 30 and the packing 7, the diameter-reduced step surface 22 is arranged at least lower than the packing washer 6, the outer diameter S2 of the diameter-enlarged portion is provided so as to be larger than the inner diameter S7 of the packing washer and, when the stem 4 rises to the operating portion 5 side, the diameter-reduced step surface 22 is locked to the packing washer 6 to prevent the stem 4 from being pulled out to the operating portion 5 side. Thus, when a force for trying to move upward is applied to the stem 4, pullout of the stem 4 from the body 2 is reliably prevented.

In this case, when a force for trying to move upward against the body 2 is applied to the stem 4, as causing the packing 7 to deform by the strength of the force, the diameter-reduced step surface 22 passes through its inner circumferential side to become in a state of having moved to a lower position of the packing washer 6. Here, the stem 4 tries to pop upward as its outer circumference being supported by the bearing members 26 and 27 and others and in a centered state, the stem 4 can make press-contact with the packing washer 6 in a state of less vibration.

Here, a stroke L when the diameter-reduced step surface 22 rises is suppressed to a distance from a portion near a lower portion of the packing 7 to the bottom surface of the packing washer 6 above the packing 7. The stem 4 moves upward in a state in which tilt against the gland 8 and the packing washer 6 is suppressed, and the diameter-reduced step surface 22 abuts on the bottom surface of the packing washer 6 in a state of being substantially centered. Thus, a large locking area of the diameter-reduced step surface 22 with respect to the packing washer 6 can be ensured, reliably preventing pullout of the stem 4 from the body 2.

Since the diameter-reduced step surface 22 is an annular flat surface, this diameter-reduced step surface 22 is in a state of annually making a surface contact with a bottom surface side of the packing washer 6 with a substantially uniform force, thereby preventing an unbalanced force from being applied from the stem 4 to the gland 8. Thus, it is possible to prevent the stem 4 from being pulled out in a state in which a sealing force by the packing 7 is kept, and it is also possible to keep sealability and torque capability at the time of operation of the stem 4 while a state in which the valve disk 3 can be rotatably operated by the stem 4 is ensured.

Here, when the stem 4 rises, the diameter-reduced step surface 22 first abuts on the lowermost portion of the packing 7 and stops there. Then, when the rising force of the stem is too strong, as described above, the stem shoves the packing 7 to further rise and abut on the packing washer 6, and becomes unable to rise further. That is, according to the present embodiment, it is possible to stop rising of the stem 4 with two steps by the packing 7 and the packing washer 6, and thus the effect of preventing the stem 4 from being pulled out is extremely excellent.

Since the valve body 1 is configured so that the packing 7 and the packing washer 6 are attached to the packing accommodation chamber 16 inside the stem shaft insertion portion 10 and fastening by the fastening bolts 32 presses the gland 8, it is possible to improve sealability and recover sealability by additionally fastening the gland 8 at the time of assembling the valve body 1 or when shaft sealability is decreased. At the time of assembling the valve body 1, it is only required to fasten the gland 8 so as to shaft sealability around the stem 4 by the packing 7 is sufficiently obtained. In the present invention, with the diameter-reduced step surface 22 positioned lower than the packing accommodation chamber 16, it is possible, in theory, to fall until the packing pressing portion 30 and the packing washer 6 completely crush the packing 7. Thus, the valve body is configured so that additional fastening is applied as required in accordance with a decrease in sealability due to a crush of the packing 7, etc.

At the time of additional fastening, when the packing washer 6 is pressed by the lower end face 30a of the packing pressing portion 30, the outer circumferential side of this packing washer 6 is firmly retained by the inner circumferential surface of the packing accommodation chamber 16 to suppress tilt. With this packing washer 6 pressed by the packing pressing portion 30 from an approximately perpendicular direction, tilt of the packing washer 6 tends not to occur. Thus, the inner diameter S7 of the packing washer 6 can be designed to be reduced to the extent of not in contact with the outer diameter S1 of the diameter-reduced portion. In this case, it becomes easy to lock the diameter-reduced step surface 22 to the inner circumferential edge side of the packing washer 6, and it is possible to manufacture the stem 4 while a difference in dimension between the outer diameter S2 of the diameter-enlarged portion and the outer diameter S1 of the diameter-reduced portion is set to a minimum, prevent an excessive reduction of the diameter of the diameter-reduced portion 20, and also ensure strength of the entire stem 4.

At the time of pressing the packing 7 by the gland 8, the movement of the packing washer 6 to a pressing direction is not restricted. Thus, it is possible to directly transfer the amount of additional fastening from the gland 8 to the packing 7 from the packing washer 6 and efficiently recover shaft sealability.

Since the diameter-reduced step surface 22 is provided at a position lower than the packing accommodation chamber 16, when this diameter-reduced step surface 22 is formed, it is possible to provide the diameter-reduced portion 20 at a position of appropriately sealing the packing 7 in the packing accommodation chamber 16.

Also, the diameter-reduced step surface 22 is not locked to the gland 8 above the packing 7, and it is not required to separately provide a space for accommodating the diameter-reduced step surface 22 in the stem shaft insertion portion 10 (body 2). Thus, it is not required to apply special processing for the diameter-reduced step surface 22 to these gland 8 and stem shaft insertion portion 10 (body 2).

In addition to this, since the gap portion G is provided between the diameter-reduced step surface 22 and the packing accommodation chamber 16, the packing washer 6 pressed by the packing pressing portion 30 does not interfere with the diameter-reduced step surface 22 both at normal times and at the time of additional fastening of the packing 7.

At the time of additional fastening by the gland 8 or the like, even if the packing washer 6 pressed by this gland 8 reaches the bottom surface of the packing accommodation chamber 16, a contact with the diameter-reduced step surface 22 can be avoided. Since it is not required to provide a space required for fastening the packing 7 inside the gland 8, in a state in which the height of the gland 8 is not extended and its compactness is kept, the packing 7 can be pressed by fastening, at maximum, from the bottom surface of the packing washer 6 to the bottom surface of the packing accommodation chamber 16. With this additional fastening, recovery of shaft sealability can be made.

The stroke L including the height of the gap G is set within an area configuring the stem shaft insertion portion 10 provided on a body 2 side. Thus, it is possible to ensure a mechanism for preventing pullout of the stem and an area for additionally fastening the packing 7 without extending the stem shaft insertion portion 10 (body 2) in an up-down direction. With this sufficient additional fastening area, shaft sealability can be recovered.

As described above, it is not required to provide a portion for locking the diameter-reduced step surface 22 above the gland 8, and a space for the diameter-reduced step surface 22 to move is not required inside the gland 8. Thus, it is possible to configure the gland 8 so that its entire height is short and downsize the valve body 1 to the rotation axis P direction.

Since the above-described space is not required, while the inner diameter of the insertion holes 33 of the gland 8 is slightly larger than the outer diameter S1 of the diameter-reduced portion, it is possible to uniformly form the thickness of the packing pressing portion 30 in the up-down direction without enlarging its diameter. By suppressing an increase in diameter of the packing pressing portion 30 in a radial direction and preventing an increase of the stem shaft insertion portion 10, to which this packing pressing portion 30 is inserted, in an outer diameter direction, it is possible to downsize the valve body 1 around the rotation axis P.

When the packing pressing portion 30 is inserted into the packing accommodation chamber 16, it is possible to make the outer circumferential surface of this packing pressing portion 30 in a state of adhering to the inner circumferential surface of the packing accommodation chamber 16. On the other hand, since it is not required to enlarge the inner diameter of the gland 8 than the outer diameter of the stem 4, it is possible to mount the body 2 and the stem 4 in a state of suppressing relative tilt. The packing pressing portion 30 can be formed to have a uniform thickness, and does not have a portion partially protruding to the outer circumferential side of this packing pressing portion 30 and the insertion hole 33 of the gland 8. Thus, when the stem 4 is moved to an upward direction or the like, galling of the stem 4 and the gland 8 tends not to occur.

The packing washer 6 is attached between the packing pressing portion 30 and the packing 7 and this packing washer 6 is provided to have an area that can press an approximately entire surface on the upper surface side of the packing 7. Thus, at the time of additional fastening described above or the like, the packing pressing portion 30 is provided to a position near the outer circumference of the stem 4, and abutting sides of these can abut with a wide abutting plane. Thus, the entire upper surface side of the packing 7 is pressed by the packing pressing portion 30 with a fastening force of the gland 8 to uniformly compress the entirety of this packing 7 to the axial direction, and shaft sealing is made between the diameter-reduced portion 20 and the packing accommodation chamber 16 in a state in which a sufficient sealing force is exerted.

Since the diameter-reduced step surface 22 formed on the stem 4 is locked to the packing washer 6 to prevent the stem 4 from being pulled out, an increase in the number of components can be prevented. At the time of assembling the valve body 1, it is only required to insert the stem 4 into the body 2 from the upper through hole 11 and attach the packing 7, the packing washer 6, and the packing pressing portion 30 from above in this sequence to the diameter-enlarged portion 21 and the diameter-reduced portion 20 of this stem 4. With this, assembling becomes easy and, also, while deformation and so forth of the packing 7 and the packing washer 6 are prevented, it is possible to accurately attach these to the predetermined positions on the outer circumference of the diameter-reduced portion 20.

At the time of forming the stem 4, the diameter-reduced step surface 22 can be provided by machining of the diameter-reduced portion 20. By using a difference in the outer diameter between the diameter-reduced portion 20 and the diameter-enlarged portion 21 as it is, the diameter-reduced step surface 22 can be provided. In this case, simultaneously with machining of the diameter-reduced portion 20, it is possible to smooth surface roughness on an attachment side of the packing 7 to enhance sealability. Thus, by providing the diameter-reduced portion 20, the diameter-enlarged portion 21, and the diameter-reduced step surface 22 so as to satisfy a predetermined position relation and size (diameter) relation thereamong, it is possible to prevent the stem from being pulled out without performing addition of another component and another processing. This also can contribute to low cost, ease of assembly, and sealability.

On the hand, finishing of the outer circumferential side of the diameter-enlarged portion 21 or the like can be omitted. In addition to this, since the packing 7 does not abut on the stem portion 29, finishing of the outer circumferential side of this stem portion 29 can also be omitted. From these, the diameter-enlarged portion 21 and the stem portion 29 can also be used as they are in a casting-surface state.

The structure is such that the diameter-reduced-shape portion 23 is formed on the circumferential surface of the stem of the diameter-reduced step surface 22 on the valve disc 3 side and the bearing 9 is attached to this diameter-reduced-shape portion 23. Thus, at the time of forming the stem 4, by providing the outer diameter S3 of the diameter-reduced step surface substantially equal to the outer diameter S2 of the stem portion 29, it is possible to process the diameter-reduced-shape portion 23 to the stem 4 and, at the same time, process the diameter-reduced step surface 22 on an upper side across this diameter-reduced-shape portion 23 from the stem portion 29. From this, when the diameter-reduced-shape portion 23 is provided to the stem 4, it is also possible to adjust the formation position of this diameter-reduced-shape portion 23 and form a lower side of the diameter-reduced step surface 22 with any thickness.

Furthermore, in the present embodiment, the diameter-reduced step surface 22 is further lower than the packing 7, and the outer diameter of this diameter-reduced step surface 22 is set larger than the outer diameter of the packing 7. Thus, for example, at the time of maintenance of the rotary valve or the like, after the operating portion 5 and the gland 8 are removed, the stem 4 is pulled up, thereby causing the diameter-reduced step surface 22 to abut on a lower portion of the packing 7 and causing the packing 7 to be pulled up together with the stem 4. When this diameter-reduced step surface 22 is located upper than the packing 7, the packing 7 remains even if the stem 4 is pulled up, and therefore the packing 7 has to be taken out separately, which is cumbersome. However, in the present embodiment, the packing 7 can be easily taken out, and thus this is extremely advantageous for maintenance, for example, replacement of the packing 7 or the like.

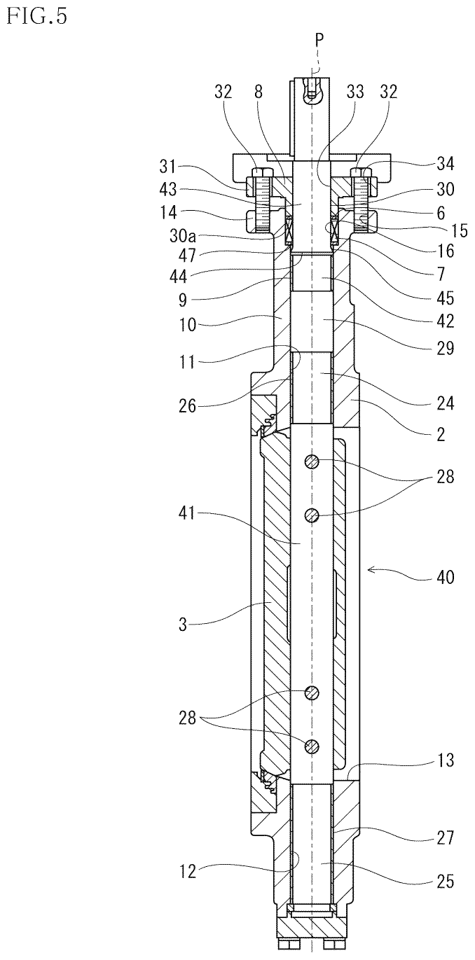

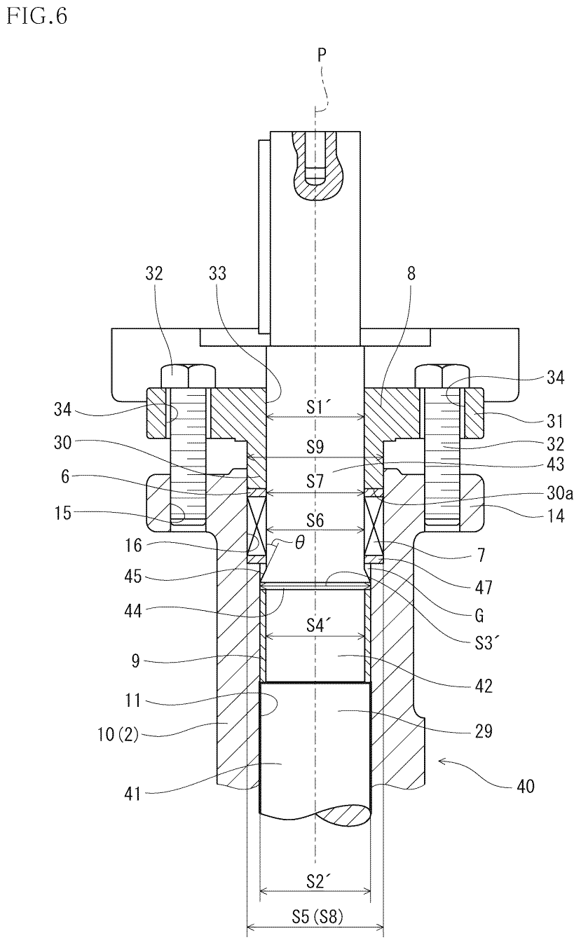

FIG. 5 depicts a second embodiment of the rotary valve in the present invention, and FIG. 6 is an enlarged sectional view of main portions of FIG. 5, depicting a state before a force of moving upward is applied to the stem. Note that portions identical to those of the above-described embodiment are represented with the same reference characters and their description is omitted in this embodiment,

A valve body 40 in this embodiment is suitable, in particular, when provided to a large diameter, and a stem 41 is rotatably operated by an actuator not depicted. In this mode, an outer diameter S4′ of a diameter-reduced-shape portion 42 for attachment of the bearing 9 in the stem 41 is provided so as to be larger than an outer diameter S1′ of a diameter-reduced portion 43 where the packing 7 is attached. In this manner in a state of a relation of the outer diameter S1′ of the diameter-reduced portion<the outer diameter S4′ of the diameter-reduced-shape portion, a diameter-reduced step surface 45 is formed at a boundary portion between the diameter-reduced portion 43 and a diameter-enlarged portion 44. The diameter-reduced step surface 45 is formed of a tapered surface with its diameter reduced from the diameter-enlarged portion 44 toward the diameter-reduced portion 43 and, with this diameter-reduced step surface 45, the diameter-enlarged portion 44 and the diameter-reduced portion 43 are smoothly connected together. The diameter-reduced step surface 45 is formed so that an angle θ against the rotation axis P is, for example, substantially 30 degrees.

With this, when the stem 41 is used in a shared manner in the valve body 40 with a large diameter or the like, the diameter-reduced portion 43 is provided so as to have a diameter smaller than that of the diameter-reduced-shape portion 42 and, if a difference in outer diameter between the diameter-reduced portion 43 and the diameter-enlarged portion 44 becomes larger, with the diameter-reduced step surface 45 being formed in a tapered surface (or a rounded surface not depicted), it is possible to suppress a decrease in strength on a diameter-reduced portion 43 side. The diameter-reduced step surface is provided so as to have an outer diameter S3′ equal to an outer diameter S2′ of the diameter-enlarged portion 44.

The packing washer (packing retaining member) 6 is provided, as with the above-described embodiment, between the packing pressing portion 30 of the gland 8 and the packing 7. With this packing washer 6, the diameter-reduced step surface 45 of the stem 41 is provided so as to be able to be locked inside the stem shaft insertion portion 10. On a bottom surface side of the packing 7, a washer member 47 separate from the packing washer 6 is further attached. With this washer member 47, protrusion of the packing 7 deformed due to additional fastening or the like to the gap portion G side is prevented, and the surface pressure of the packing 7 is kept. Thus, even if the gap portion G is extended by providing the valve body 40 with a large diameter, the packing 7 is appropriately pressed inside the packing accommodation chamber 16 to keep shaft sealability. The same one as the packing washer 6 can be used for the washer member 47.

When a force of trying to move upward is applied to the stem 41 of the valve body 40, that force causes the diameter-reduced step surface 45 formed of the tapered surface to abut on an inner circumferential edge side of the washer member 47 to push this washer member 47 up to rise while crushing the packing 7. Here, the inside of the stem shaft insertion portion 10 becomes in a state in which, the diameter-reduced step surface 45, the washer member 47, and the crushed packing 7, and the packing washer 6 are stacked in this sequence from below, and the diameter-reduced step surface 45 keeps the state of pressing the washer member 47.

With this, the force of the stem 41 for trying to rise is applied to the packing washer 6. Since the packing washer 6 is in a state of being pressed from above by the gland 8, further rising of the stem 41 is prevented, and pullout from the body 2 is prevented. Here, since an angle θ of the diameter-reduced step surface 45 is provided by a tapered surface with substantially 30 degrees, this diameter-reduced step surface 45 abuts on the inner circumferential edge of the washer member 47 in linear contact, the tapered surface (diameter-reduced step surface) 45 gradually enters an inner diameter side of the washer member 47 and, when the diameter becomes larger than the inner diameter of this washer member 47, the stem 41 is locked to the packing washer 6 across the washer member 47 and the packing 7. Finally, the stem 41 is prevented from being pulled out by the packing washer 6. Thus, an abrupt impact is prevented from being applied to prevent damages and so forth of the stem 41 and the packing washer 6, and an effective pullout prevention effect for the stem 41 is exerted.

Furthermore, when the stem 41 is pressed onto the washer member 47, the stem 41 becomes in a centered state against the stem shaft insertion portion 10 via a linear contact between the diameter-reduced step surface 45 and the washer member 47 and, also, together with support by the bearing members 26 and 27. Thus, vibration on the diameter-reduced portion 43 can also be suppressed. Since diameter-reduced step surface 45 is provided so as to have a tapered shape, its processing is easy.

As described above, even in the case of the valve body 40 having a large diameter, as with the case of a small diameter, pullout of the stem 41 is reliably prevented and, as these, a valve body of any size from a small diameter to a large diameter can be supported.

While the embodiments of the present invention have been described in detail in the foregoing, the present invention is not limited to the description of the embodiments above, and can be variously changed in a range not deviating from the spirit of the invention described in the claims of the present invention. For example, the invention can be applied also to a valve that is other than a rotary valve and includes a structure of shaft-sealing the stem (operating shaft) with the packing attached to the packing accommodation chamber, and can be also applied to a shaft-sealing structure other than a valve, such as piping equipment.

### REFERENCE SIGNS LIST

1, 40 valve body

2 body

3 valve disk

5 operating portion

4, 41 stem

6 packing washer (packing retaining member)

7 packing

8 gland

9 bearing

10 stem shaft insertion portion

16 packing accommodation chamber

20, 43 diameter-reduced portion

21, 44 diameter-enlarged portion

22, 45 diameter-reduced step surface

23 diameter-reduced-shape portion

30 packing pressing portion

30a lower end face

S2 outer diameter of the diameter-enlarged portion

S7 inner diameter of the packing washer

1. A rotary valve in which a valve disk is provided inside a body having a stem shaft insertion portion, one end of a stem shaft-inserted into the stem shaft insertion portion is connected to the valve disk and another end thereof is connected to an operating portion, and the valve disk is rotatably provided via the stem by operation of the operating portion, wherein a packing accommodation chamber for packing accommodation is provided inside the stem shaft insertion portion on the operating portion side, a diameter-reduced portion is provided on the operating portion side of the stem, a diameter-enlarged portion with a diameter enlarged more than the diameter-reduced portion is provided on the valve disk side of the stem, a diameter-reduced step surface is formed at a boundary portion between these diameter-reduced portion and diameter-enlarged portion, a gland having a packing pressing portion is provided on the operating portion side of the stem, an annular packing retaining member is interposed between a lower end face of the packing pressing portion and the packing, the diameter-reduced step surface is arranged at least lower than the packing retaining member, the diameter-enlarged portion has an outer diameter larger than an inner diameter of the packing retaining member and, when the stem rises to the operating portion side, the diameter-reduced step surface is locked to the packing retaining member to prevent pullout of the stem to the operating portion side.

2. The rotary valve according to claim 1, wherein the diameter-reduced step surface is formed as a flat surface, a tapered surface, or a rounded surface

3. The rotary valve according to claim 1, wherein the diameter-reduced step surface is positioned lower than the packing accommodation chamber.

4. The rotary valve according to claim 1, wherein a diameter-reduced-shape portion is formed on a circumferential surface of the stem on a valve disk side of the diameter-reduced step surface, and a bearing is attached to this diameter-reduced-shape portion.
